(19) United States
(12) Patent Application Publication
(10) Pub. No.: US 2006/0239223 A1
(43) Pub. Date: Oct. 26, 2006

(54) Method and system for bluetooth and wireless local area network coexistence

(76) Inventors: Itay Sherman, Raanan (IL); Lior Ophir, Herzlia (IL)

Correspondence Address: TEXAS INSTRUMENTS INCORPORATED, P O BOX 655474, M/S 3999, DALLAS, TX, 75265, US

(21) Appl. No.: 11/111,379

(22) Filed: Apr. 21, 2005

(51) Int. Cl. H04Q 7/00; H04Q 7/24

(52) U.S. Cl. 370/329; 370/338

(57) ABSTRACT

A method of transferring data between an access point and a station in a coexistent wireless local area network (WLAN) during a period that falls between successive Bluetooth (BT) slots, in which the access point response time may be relatively short or relatively long. A system for a coexistent WLAN including an access point that identifies or broadcasts a management frame including a coexistent information element, a station that recognizes or receives the management frame upon registration, and a coexistent operation that downloads a data frame from the access point to the station either between the two successive BT slots.

### CROSS-REFERENCE TO RELATED APPLICATIONS

None

### FIELD OF THE INVENTION

The present invention generally relates to a method and system for the coexistence, i.e., the avoidance of radio interference over a common radio frequency band, of Bluetooth (BT) and wireless local area networks (WLANs). More particularly, the present invention relates to a method of transferring data between an access point and a station in a coexistent WLAN either between two successive Bluetooth voice slots or by providing a contention-free WLAN period for a Bluetooth voice slot. Yet more particularly, the present invention provides WLAN management frames that identify WLAN coexistent networks.

### BACKGROUND OF THE INVENTION

Wireless communication devices are generally constrained to operate in a certain frequency band of the electromagnetic spectrum. The use of many such bands is licensed by government regulatory agencies, for example, the U.S. Federal Communications Commission and the European Radio Communications Office. A licensee, such as a TV broadcast station, generally transmits at high power over a large area in the particular frequency band to which it has obtained a license. Licensing is necessary, in such cases, to prevent interference between multiple broadcasters trying to use the same frequency band in an area.

Regulatory agencies also stipulate frequency bands for devices that emit radio frequencies, where licensing is not required. Wireless communication devices using these unlicensed frequency bands generally transmit at low power over a small area. One such frequency band is the ISM band located between 2.4 to 2.5 GHz, which is set aside for industrial, scientific, or medical equipment. This 2.4 GHz band is used by many wireless communication devices for data and/or voice communication networks.

One such communication network is defined by the Bluetooth specification. Bluetooth specifies communication protocols for low cost, low power wireless devices that operate over a very small area, the so-called, personal area network. These wireless devices may include, for example, telephone headsets, cell phones, Internet access devices, personal digital assistants, laptop computers, etc. Typically, the Bluetooth specification seeks to replace a connecting cable between communicating devices, for example, a cell phone and a headset, with a wireless radio link to provide greater ease of use by reducing the tangle of wires frequently associated with personal communication systems. Several such personal communication devices may be “wirelessly” linked together by using the Bluetooth specification, which derives its name from Harald Blatand (Blatand is Danish for Bluetooth), a 10th century Viking king who united Denmark and Norway.

Because Bluetooth devices operate in the unlicensed 2.4 GHz radio frequency band, they are subject to radio interference from other wireless devices operating in the same frequency band. To avoid radio frequency interference, the Bluetooth specification divides the 2.4 to 2.5 GHz frequency band into 1 MHz-spaced channels. Each channel signals data packets at 1 Mb/s, using a Gaussian Frequency Shift Keying modulation scheme. A Bluetooth device transmits a modulated data packet to another Bluetooth device for reception. After a data packet is transmitted and received, both devices retune their radio to a different 1 MHz channel, effectively hopping from radio channel to radio channel, i.e., frequency-hopping spread spectrum (FHSS) modulation, within the 2.4 to 2.5 GHz frequency band. In this way, Bluetooth devices use most of the available 2.4 to 2.5 GHz frequency band and if a particular signal packet transmission/reception is compromised by interference on one channel, a subsequent retransmission of the particular signal packet on a different channel is likely to be effective.

Bluetooth devices operate in one of two modes: as a Master device or a Slave device. The Master device provides a network clock and determines the frequency hopping sequence. One or more Slave devices synchronize to the Master's clock and follow the Master's hopping frequency.

Bluetooth is a time division multiplexed system, where the basic unit of operation is a time slot of 625 μs duration. The Master device first transmits to the Slave device during a first time slot of 625 μs with both devices tuned to the same radio frequency channel. Thus, the Master device transmits and the Slave device receives during the first time slot. Following the first time slot, the two devices retune their radios, or hop, to the next channel in the frequency hopping sequence for the second time slot. During the second time slot, the Slave device must respond whether it successfully understood, or not, the last packet transmitted by the Master during the first time slot. Thus, the Slave device transmits and the Master device receives during the second time slot. As a Slave device must respond to a Master's transmission, communication between the two devices requires at a minimum two time slots or 1.25 ms.

Data packets, when transmitted over networks, are frequently susceptible to delays by, for example, retransmissions of packets caused by errors, sequence disorders caused by alternative transmission pathways, etc. Packet delays do not cause much of a problem with the transmission of digital data because the digital data may be retransmitted or re-sequenced by the receiver without effecting the operation of computer programs using the digital data. However, packet delays or dropped packets during the transmission of voice signals can cause unacceptable quality of service.

The Bluetooth specification version 1.1 provides a Synchronous Connection Oriented (SCO) link for voice packets that is a symmetric link between Master and Slave devices with periodic exchange of voice packets during reserved time slots. The Master device will transmit SCO packets to the Slave device at regular intervals, defined as the SCO interval or T_{SCO}, which is counted in time slots. Bandwidth limitations limit the Bluetooth specification to a maximum of three SCO links. Hence, the widest possible spacing for an SCO pair of time slots, which are sometimes called a voice slot, is every third voice slot. Bluetooth specification version 1.2 provides enhanced SCO links, i.e., eSCO links, which have a larger voice slot size, based on N*625 μs time slots, with larger and configurable intervals between voice slots. These eSCO links can be used for both voice or data applications.

The Institute of Electronic and Electrical Engineer's (IEEE's) 802.11 specification for wireless local area networks (WLANs) is also a widely used specification that may define a method of radio frequency modulation, i.e., direct sequence spread spectrum (DSSS) and/or high-rate direct sequence spread spectrum (HR/DSSS), which also uses the same 2.4 GHz radio frequency band as Bluetooth devices. Hence, one would expect the problem of radio interference to occur when Bluetooth and WLAN devices try to communicate simultaneously over the same radio frequency band.

Direct-sequence modulation is a spread spectrum technique that is used to transmit a data packet over a wide frequency band. The basic approach is to smear the radio frequency energy over a wide band in a mathematically controlled way. Changes in the radio carrier are present across a wide band and receivers perform correlation processes to look for changes. Correlation provides DSSS and HR/DSSS transmissions excellent protection against radio interference because noise tends to take the form of relatively narrow pulses that do not produce coherent effects across the entire frequency band. Hence, the correlation function spreads out the noise across the band, while the correlated signal shows a much greater amplitude of signal. Direct-sequence modulation trades bandwidth for throughput.

WLANS may operate as independent networks, in which stations, e.g., laptop computers, communicate directly with each other, or as infrastructure networks that comprise stations, which are radio linked to a wired backbone network, e.g., Ethernet, by an access point. An access point that is associated with one or more stations forms an infrastructure service set, which provides network services to an infrastructure basic service area. All communication between stations in an infrastructure service set must go through an access point. Each station, at any point in time, is only associated with one access point. If a station, i.e., the source, in an infrastructure service set needs to communicate with another station, i.e., the destination, the source station first transmits by radio a data packet to its access point. The access point receives the radio transmission and then transmits the data packet to the destination station.

Several access points may be linked to a wired backbone network to form an extended service set comprising multiple infrastructure service sets and forming a corresponding extended service area. Generally, access points are located along the wired backbone network to form overlapping infrastructure service areas, allowing for movement of a station from a first infrastructure service area to a second infrastructure service area without loss of communication between other stations of the extended service set.

Access points, which derive their power from the wired backbone network, assist stations, which are typically battery-powered, to save power. Access points can note when a station enters a power-saving mode, i.e., a sleep state, and buffer packets directed to the sleeping station. Thus, battery-powered stations can turn their wireless transceiver off and power it up only to transmit and retrieve buffered data packets from the access point. This power saving by mobile stations is one of the most important features offered by an infrastructure network.

WLANs must manage the communication of information from stations to a network in order for stations in search of connectivity to locate a compatible wireless network, to authenticate a mobile station for connection to a particular wireless network, and to associate a mobile station with a particular access point to gain access to the wired backbone network. These management communications are defined under the WLAN specification by the Media Access Control (MAC). The MAC includes a large number of management frames that communicate network management functions, e.g., a Request for Association from a station to an access point, in an infrastructure network.

A station may locate an existing WLAN network by either passive scanning or active scanning. Passive scanning saves battery power because it does not require transmitting. The station may awaken from a sleep mode and listen, i.e., scan, for a Beacon management frame, which broadcasts the parameters and capabilities of an infrastructure network from an access point. From the traffic indication map of the Beacon frame, the station can determine if an access point has buffered traffic on its behalf. To retrieve buffered frames, the station can use a Power Save (PS)-Poll control frame. Active scanning requires that the station actively transmit a Probe Request frame to solicit a response from an infrastructure network with a given name and of known parameters and capabilities. After determining that a responding network of a given name and of known parameters and capabilities is present, the station sequentially joins, authenticates, and lastly requests an association with the responding network by transmitting an Association Request management frame. After receipt of the Association Request frame, an access point responds to the station with an Association Response management frame and the station now has access to the wired backbone network and its associated extended service area.

Management frames, such as an Association Request from a station, or an Association Response, a Beacon, and a Probe Response from an access point, include a MAC header, a frame body containing information elements and fixed fields, and a frame check sequence. Information elements are variable-length components of management frames that contain information about the parameters and capabilities of the network's operations. A generic information element has an ID number, a length, and a variable-length component. Element ID numbers are defined by IEEE standards for some of the 256 available values, other values are reserved. The value 221 is used for vendor specific extensions and is used extensively in the industry.

As Bluetooth personal area networks and WLANs use the same ISM radio frequency band of 2.4 GHz to 2.5 GHz, radio interference between the different devices can degrade network communications, e.g., decreased data throughput and quality of voice service caused by retransmissions resulting from interference. Therefore, there remains a need for a method and system that will provide coexistence, i.e., the absence of radio interference, between Bluetooth and WLAN devices operating as a combination device or as wireless communication networks in the same area.

### SUMMARY OF THE INVENTION

An aspect of an exemplary embodiment of the present invention provides a method of transferring data between an access point and a station in a coexistent wireless local area network (WLAN) that includes sending a frame from the station to the access point after a Bluetooth (BT) voice slot and setting a duration field of the frame to cover a next BT voice slot, and transferring a data frame from the access point to the station, in which the transferring of the data frame occurs between the BT voice slot and the next BT voice slot.

Another aspect of an exemplary embodiment of the present invention provides a method of transferring data between an access point and a station in a coexistent wireless local area network (WLAN) that includes sending a first frame from the station to the access point after a first Bluetooth (BT) voice slot and the station receiving an acknowledgment frame from the access point, sending a second frame from the station to the access point that reserves a wireless medium to the station of the coexistent WLAN and setting a duration field of the second frame to cover a second BT voice slot, transferring a data frame from the access point to the station after the second BT voice slot, and acknowledging by the station, receipt of the data frame, in which the sending a second frame provides a contention-free WLAN period for the second BT voice slot.

Yet another aspect of an exemplary embodiment of the present invention provides a system for a coexistent wireless local area network (WLAN) including an access point that identifies a management frame including a coexistent information element, a station that sends the management frame to the access point upon registration, and a coexistent operation that transfers data between the access point and the station between successive Bluetooth (BT) voice slots.

Yet another aspect of an exemplary embodiment of the present invention provides a system for a coexistent wireless local area network (WLAN) including an access point that broadcasts a management frame including a coexistent information element, a coexistent station that registers with the access point, and a coexistent operation that transfers data between the access point and the station between successive Bluetooth (BT) voice slots.

### BRIEF DESCRIPTION OF THE DRAWINGS

Exemplary embodiments of the present invention are discussed hereinafter in reference to the drawings, in which:

FIG. 1 illustrates a generic management frame defined by the Media Access Control (MAC) of a coexistent WLAN that may contain an information element signifying coexistent operations between a Bluetooth network and the coexistent WLAN in an exemplary embodiment of the present invention; and

FIG. 2 illustrates a timing diagram of a coexistent WLAN operation for transferring frames to and from an access point that has relatively short response time to a station between two successive Bluetooth voice slots in an exemplary embodiment of the present invention; and

FIG. 3 illustrates a timing diagram of a coexistent WLAN operation for transferring frames from an access point that has relatively long response time to a station between two successive Bluetooth voice slots in an exemplary embodiment of the present invention.

### DETAILED DESCRIPTION OF EXEMPLARY EMBODIMENTS

Generally, various exemplary embodiments of the present invention may provide for alternative methods for transferring data to and from an access point to a station in a coexistent wireless local area network (WLAN), in which the access point response time may be either relatively short or relatively long. In various exemplary embodiments of the present invention, a system for a coexistent wireless local area network (WLAN) may include an access point that identifies a management frame including a coexistent information element, a station that may send the management frame to the access point upon association, and a coexistent operation that may download a data frame from the access point to the station between two successive Bluetooth (BT) voice slots. Alternatively, the system for a coexistent wireless local area network (WLAN) may include an access point that broadcasts a management frame including a coexistent information element, a station that may associate with the access point, and a time division multiplexed coexistent operation that may download a data frame from the access point to the station, after setting a contention-free WLAN period for a BT voice slot.

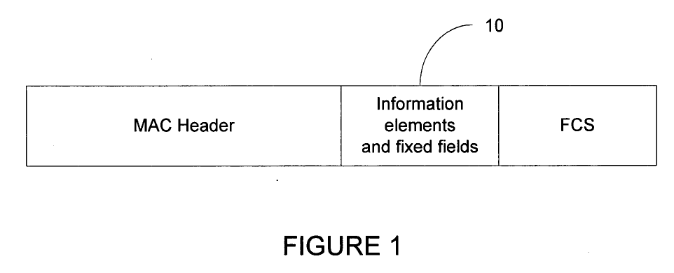

The managed WLAN function of coexistence, i.e., the absence of radio frequency interference in the commonly used 2.4 GHz frequency band by a Bluetooth network and an WLAN, may be identified and communicated between a station and an access point by providing an information element in MAC-defined management frames to define the coexistent parameters and capabilities. Information designating the existence of a coexistence mechanism and the operating parameters of the coexistence mechanism may be used by an access point to selectively perform a corresponding set of algorithms to facilitate coexistence between the Bluetooth and WLAN system of a station. FIG. 1 illustrates a generic management frame defined by the WLAN MAC specification that may include one or more information elements 10, which may signify coexistence for the WLAN in the presence of a Bluetooth network. In various exemplary embodiments of the invention, this generic management frame may describe, for example, an Association Request, an Association Response, a Beacon, and/or a Probe Request. For example, the Association Request may be transmitted from a station to an access point with which the station is to be associated and may include an information element identifying the station as coexistent with a Bluetooth network. Similarly, in various exemplary embodiments of the invention, the Association Response, the Beacon, and the Probe Request may be transmitted from an access point and may include an information element identifying the access point and its associated wired backbone network as coexistent with a Bluetooth network. The coexistent capabilities of the network may also include MAC-defined communication operations between an access point and an associated station.

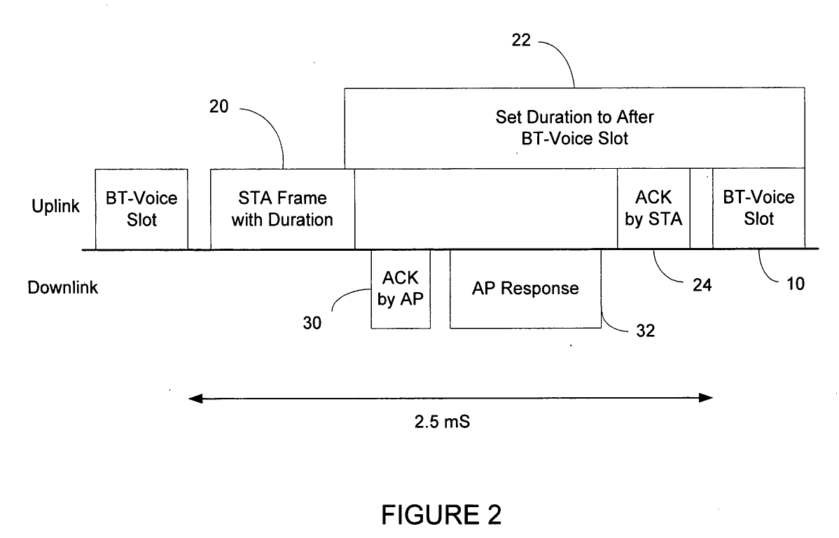

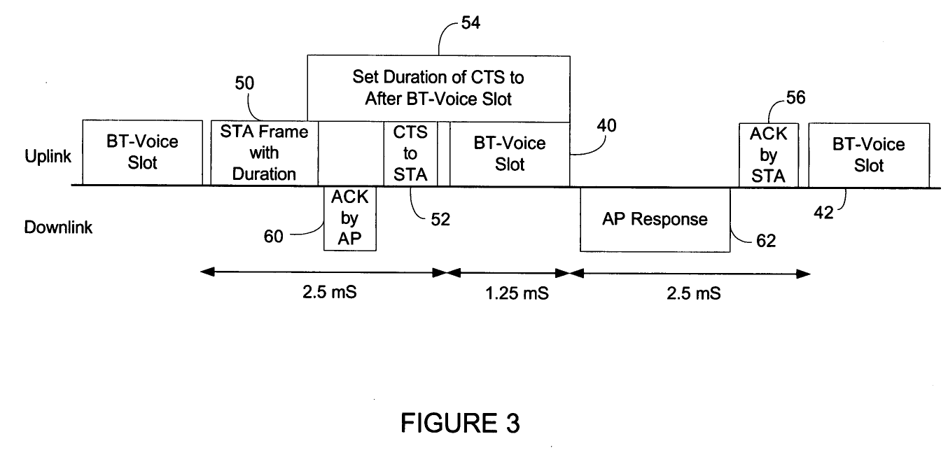

FIGS. 2 and 3 illustrate time division multiplexed operations that may facilitate coexistence between a Bluetooth network and a WLAN in various exemplary embodiments of the present invention. FIG. 2 illustrates the time division multiplexed sequence of a coexistent operation when the response time of the access point is relatively short; while FIG. 3 illustrates the time division multiplexed sequence of another coexistent operation when the response time is long.

In FIGS. 2 and 3, a Bluetooth network may establish a Synchronous Connection Oriented (SCO) link for voice communication between a Master and a Slave device. In an exemplary embodiment of the invention, a pair of time slots having a duration of 1.25 ms, may be reserved for the BT SCO voice slot. In this exemplary embodiment, the BT SCO voice slots are repeated every 3.75 ms.

As shown in FIGS. 2 and 3, after the initial BT SCO voice slot is relinquished, a coexistent WLAN station may send a frame to the access point, in which the duration field of the frame is selected to permit coexistent communication for the Bluetooth and WLAN systems when the access point's response time is either short or long. An exemplary embodiment of the present invention may operate with Unsolicited Automatic Power Delivery (U-APSD), in which the frame sent to the access point may trigger the access point to send its buffered traffic to the station. There may be no limitation to the frame type used, which may also include data frames. In an exemplary embodiment of the present invention that uses a standard power delivery mechanism, the station may send a PS-Poll frame to trigger the access point to send its buffered traffic. In this case, the station may send both a PS-Poll frame followed by a data frame before allowing the access point to send its buffered data. The access point then positively acknowledges the frames sent by the station.

As shown in FIG. 2, when the access point response time is relatively short, i.e., the duration of the access point's response 32 to the station is short, the station may transmit a frame 20 or a sequence of frames with their duration fields 22 set to after the next BT voice slot. The frames may then be acknowledged by the access point in 30. Since the duration field in the frames sent from the station is set to after the next BT voice slot, no other station but the access point will be able to transmit during this time period and the access point will be able to send to the station, the traffic that is buffered for it in 32. The station may then acknowledge the frame received from the access point in 24. In various exemplary embodiments, the entire exchange between station and access point is limited to 2.5 msec, which is the time period between successive BT voice slots.

The time multiplexed coexistent operation illustrated in FIG. 2 may allow a coexistent WLAN operation to occur between successive Bluetooth SCO voice slots and within the Bluetooth SCO interval of 2.5 ms; thus, providing coexistent communications for the Bluetooth network and the WLAN by avoiding radio interference on the common wireless medium.

If the access point response time is relatively long, WLAN communication as shown in FIG. 2 could extend beyond the Bluetooth SCO interval into the following BT voice slot 10 causing radio interference.

As shown in FIG. 3, when the access point response time is relatively long, the station may transmit ones or more frames to the access point, for example, standard frames for UPSD and PS-Poll for standard power save, in 50 and receive acknowledgment for these frames from the access point in 60. In various exemplary embodiments, this acknowledgement may be immediately followed by, i.e., a Short Inter-Frame Space (SIFS) and, for example, a Clear To Send (CTS) to self frame 52 with its duration field set to cover the subsequent BT voice slot 40. The access point may then be triggered by the upstream frame 50, to send downstream frames from the access point to the station in 62. The access point response 62 may only occur after deferring to after the BT voice slot 40, due to the setting of the duration field of the, for example, CTS frame 52 that was sent from the station. The station may then acknowledge the access point response in 56. This time division multiplexing allows the access point response time to be longer and enables the sending of longer packets, since the access point response time may be larger then 1 msec and the interval between successive BT voice slots, for example, 2.5 msec, may be reserved for the downlinked frames, as opposed to the method illustrated in FIG. 2, where the interval between successive BT voice slots was shared between the upstream and downstream transmission of frames between the station and the access point.

Because many varying and different exemplary embodiments may be made with the scope of the inventive concepts taught herein, and because many modifications may be made in the exemplary embodiments detailed herein in accordance with the descriptive requirements of the law, it is to be understood that the detailed descriptions herein are to be interpreted as illustrative and not in a limiting sense.

What is claimed:

1. A method of transferring data between an access point and a station in a coexistent wireless local area network (WLAN), the method comprising:
sending a frame from the station to the access point after a Bluetooth (BT) voice slot and setting a duration field of the frame to cover a next BT voice slot; and
transferring a data frame from the access point to the station,
wherein the transferring of the data frame occurs between the BT voice slot and the next BT voice slot.

2. The method of claim 1, further comprising:
acknowledging receipt of the frame from the station by the access point sending an acknowledgement frame to the station.

3. The method of claim 2, further comprising:
acknowledging receipt of the data frame from the access point by the station sending an acknowledgement frame to the access point.

4. The method of claim 1, wherein the frame sent from the station to the access point after the BT voice slot comprises at least one of a data frame and a Power Save (PS)-Poll frame.

5. The method of claim 1, wherein the BT voice slot and the next BT voice slot comprises a Synchronous Connection Oriented (SCO) link for one of data and voice.

6. The method of claim 1, wherein the BT voice slot and the next BT voice slot comprises an enhanced Synchronous Connection Oriented (eSCO) link for one of data and voice.

7. The method of claim 1, wherein a period between the BT voice slot and the next BT voice slot is 2.5 ms.

8. The method of claim 1, wherein the data frame has an upper bound of approximately 1 ms.

9. A method of transferring data between an access point and a station in a coexistent wireless local area network (WLAN), the method comprising:
sending a first frame from the station to the access point after a first Bluetooth (BT) voice slot and the station receiving an acknowledgment frame from the access point;
sending a second frame from the station to the access point that reserves a wireless medium to the station of the coexistent WLAN and setting a duration field of the second frame to cover a second BT voice slot;
transferring a data frame from the access point to the station after the second BT voice slot; and
acknowledging by the station, receipt of the data frame,
wherein the sending a second frame provides a contention-free WLAN period for the second BT voice slot.

10. The method of claim 9, further comprising:
acknowledging by the station, the receipt of the data frame from the access point.

11. The method of claim 9, wherein the first frame sent from the station to the access point after the first BT voice slot comprises at least one of a data frame and a Power Save (PS)-Poll frame.

12. The method of claim 9, wherein the first BT voice slot and the second BT voice slot comprises a Synchronous Connection Oriented (SCO) link for one of data and voice.

13. The method of claim 9, wherein the first BT voice slot and the second BT voice slot comprises an enhanced Synchronous Connection Oriented (eSCO) link for one of data and voice.

14. The method of claim 9, wherein a period between the first BT voice slot and the second BT voice slot is 2.5 ms.

15. A system for a coexistent wireless local area network (WLAN) comprising:
an access point that identifies a management frame including a coexistent information element;
a station that sends the management frame to the access point upon registration; and
a coexistent operation that transfers data between the access point and the station between successive Bluetooth (BT) voice slots.

16. The system of claim 15, wherein the successive BT voice slots comprise Synchronous Connection Oriented (SCO) links for one of data and voice and the coexistent WLAN transmits between the successive BT voice slots.

17. The system of claim 15, wherein the successive BT voice slots comprise enhanced Synchronous Connection Oriented (eSCO) links for one of data and voice and the coexistent WLAN transmits between the successive BT voice slots.

18. The system of claim 15, wherein the transfer of data from the access point to the station has an upper bound, such that the data is transferred between the successive BT voice slots.

19. A system for a coexistent wireless local area network (WLAN) comprising:
an access point that broadcasts a management frame including a coexistent information element;
a coexistent station that registers with the access point; and
a coexistent operation that transfers data between the access point and the station between successive Bluetooth (BT) voice slots.

20. The system of claim 19, wherein the successive BT voice slots comprise Synchronous Connection Oriented (SCO) links for one of data and voice and the coexistent WLAN transmits between the successive BT voice slots.

21. The system of claim 19, wherein the successive BT voice slots comprise enhanced Synchronous Connection Oriented (eSCO) links for one of data and voice and the coexistent WLAN transmits between the successive BT voice slots.

22. The system of claim 19, wherein the transfer of data from the access point to the station has an upper bound, such that the data is transferred between the successive BT voice slots.
